(19) United States
(12) Patent Application Publication
(10) Pub. No.: US 2008/0016560 A1
(43) Pub. Date: Jan. 17, 2008

(54) Access Control Method

(75) Inventors: Serge Papillon, Paris (FR); Sougandy Ragou, Orsay (FR); Francis Detot, Domene (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/813,209

(22) PCT Filed: Dec. 28, 2005
(86) PCT No.: PCT/FR05/51147

§ 371 Date: Sep. 10, 2007

(30) Foreign Application Priority Data
Dec. 31, 2004 (FR) 0453289

(51) Int. Cl. H04L 9/32

(52) U.S. Cl. 726/19

(57) ABSTRACT

The invention concerns an access control method for determining whether a given user (1) of a number of users may apply a given function of a set of functions to a given resource (2) among a plurality of resources, the resources being classified in accordance with at least one criterion. The inventive control access method comprises a step which consists in transmitting to an access control module (4) a message (5) including a user field (6) containing a group identifier of the given user, and a list of fields organized into at least one criterion field (14, 15), each criterion field containing the value of a criterion specific for the given resource.

The present invention relates to the field of access control.

This field generally involves a given user from a set of users who wishes to apply a given function from a set of functions to a resource from a set of resources. Access control finds many fields of application, to both software and hardware resources.

For example, access to a building or to certain rooms may be restricted to certain persons. Access is authorized by an access control device that controls the opening of each door.

Access to drugs in a hospital may also be restricted to certain persons, depending on the nature of the drug, i.e. nurses have access to ordinary drugs of low cost, such as aspirin, for example, whereas preparation staff have access to the entire pharmacy. Here the drugs constitute the resources and the set of users comprises a group consisting of nurses and a group consisting of preparation staff. The set of functions that the users may wish to apply comprises the physical handling of drugs.

Access control is also operative in the field of the management of computer networks. Such networks, for example the Internet, comprise a set of routers. A network management tool modifies the software of some or all of the routers: thus if one of the routers fails, the network management tool reconfigures the other routers.

Persons with different rights use the network management tool. For example, a manager has the right to shut down routers, monitoring staff can view the status of routers and deactivate alarms, while a trainee can display the status of routers and simulate shutdowns in order to be trained in network management.

Moreover, the rights of persons can be limited to a subset of routers. For example, certain persons can view only the status of a particular router, whereas others can restart all routers using a given technology.

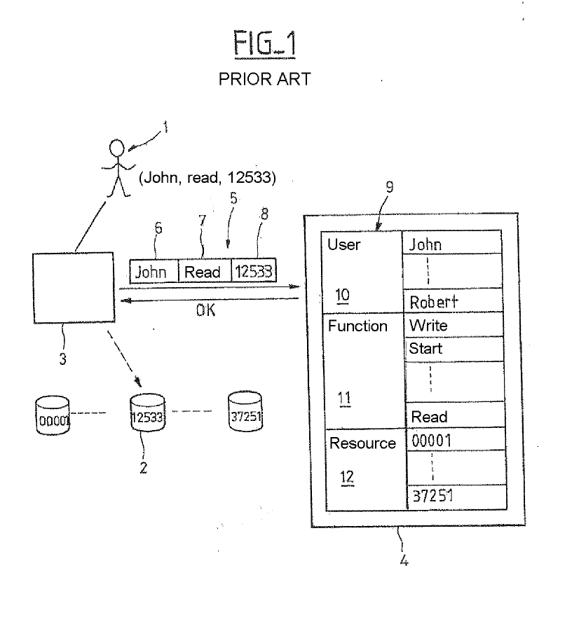

FIG. 1 illustrates the operation of one example of a prior art access control device.

If a given user 1, here John, wishes to apply to a given resource 2, here the router identified by the number 12533, a given function, here the reading of files or programs of the router, a software module 3 transmits to an access control module 4 a message 5. The message 5 includes a user field 6 containing an identifier of the given user 1, a function field 7 containing an identifier of the given function, and a resource field 8 containing an identifier of the given resource.

The access control module 4 includes a user variable 10, a function variable 11, and a resource variable 12, all allocated at the time of creation of the access control module 4. At the time of installation of the access control module 4 in a given environment, the identifiers of the users from the set of users for that environment are entered, as well as the identifiers of the functions from the set of functions and the identifiers of the resources from the set of resources.

The access control module 4 determines if the given user 1 is authorized to apply the given function to the given resource from the received identifier of the given user 1, from the received identifier of the given function, and from the received identifier of the given resource. The access control module 4 sends a response to the software module 3 after receiving the message 5. In the example represented in FIG. 1, the response is positive: the given user 1 is authorized to apply the given function to the given resource.

The number of users in the set of users is generally relatively small, for example around a hundred. Similarly, the number of functions in the set of functions is generally relatively small, for example around ten. On the other hand, the number of resources in the set of resources can be relatively high, for example of the order of one million.

Management of the access control device can therefore be relatively difficult because of the relatively high number of resource identifiers.

It is known to categorize resources into resource groups: at the time of installation of the access control module, each resource identifier can be classified according to the corresponding resource belonging to a given resource group, provided that the person who is configuring the access control module knows that categorization. A paper document specifying that each resource belongs to a given resource group is generally printed out for this purpose.

Classification of the resource identifiers simplifies programming the authorization determination algorithm: the algorithm initially determines to which group the received identifier of the given resource belongs and then determines which response to give as a function of that group and other identifiers received, i.e. the identifier of the given user and the identifier of the given function.

The access control module is configured manually, however, on the basis of a paper document detailing the categorization of resources. The present invention provides for easier access control device management.

The present invention consists in an access control method for determining if a given user from a set of users can apply a given function from a set of functions to a given resource from a set of resources, which resources can be classified in accordance with at least one criterion. The access control method of the invention includes a step of transmitting to an access control module a message including a user field containing a group identifier of the given user, and a list of fields structured as at least one criterion field, each criterion field containing the value of a particular criterion for the given resource.

The method of the present invention avoids entering and storing a relatively large number of resource identifiers in the access control module. When the access control module is installed, the person configuring the access control module does not need to know all of the resources, only potential criteria values. This clarifies and simplifies management of the access control module.

For example, if new resources are added to an existing set of resources, there is no need to enter into the access control module the identifiers of the new resources. If a given user seeks to apply a given function to a new resource, the access control module receives, instead of an identifier of the new resource, a message including a list of fields structured as at least one criterion field, each criterion field containing the value of a particular criterion for the new resource. Adding the new resource is therefore transparent for the access control module.

The method according to the present invention also economizes on access control module memory space.

The user field contains a group identifier of the given user, i.e. where appropriate an identifier of the user himself if the group of the given user is considered to comprise only one user.

The user can be human or non-human. For example, the user can be a software application seeking to apply a given function to a given resource.

The list of fields is advantageously structured as a plurality of criteria fields.

The list of fields can be structured into p criteria, for example, and in this example each criterion can assume the same number q of values. When the access control module is created, it can contain p criterion variables, each criterion variable corresponding to a criterion. At the time of installation or maintenance operations, q potential values can be entered for each criterion, that is to say p*q values. With the prior art methods, it is considered that the p criteria each able to assume q values define q^{p} resource groups. Not only must the person configuring the access control module manage the identifiers of the resources, but that person must also classify them into q^{p} groups, which is a number of groups that is often much higher than the p*q values of the method according to the present invention.

Alternatively, the list of fields comprises a single criterion field.

The message transmitted advantageously also includes a function field containing an identifier of the given function.

This feature is not limiting on the invention, however: for example, the message transmitted may include no function field if the set of functions comprises only one function or if the rights do not depend on the nature of the function.

Each criterion field advantageously also contains an identifier of the particular criterion. This feature is not limiting on the invention, of course.

Thus each criterion field contains a pair comprising a criterion identifier and a value of the criterion. The message is then transmitted in accordance with a free protocol, wherein the criterion of each criterion field can be identified by the criterion identifier. Free protocols enable greater flexibility of use as to the order of the criteria fields in the message, the choice of the criterion or criteria, etc.

Alternatively, each criterion field can contain only the value of the particular criterion for the given resource. The message is then transmitted in accordance with a fixed protocol.

The method advantageously comprises a preliminary step of authentication of the given user. The given user who wishes to apply the given function to the given resource can be authenticated first, for example by a software module. The identifier of the authenticated user can be transmitted to the access control module as a group identifier of the user.

The method can also include a step of categorization of the given user in a group, for example the group of trainees, in particular if the rights are identical for all the members of the group. An identifier of the group can be transmitted to the access control module.

Alternatively, the method according to the present invention can include a step of authentication, not of the given user, but of an enquirer seeking to find out if the given user can apply the given function to a given resource. The given user can be someone other than the enquirer.

Alternatively, the method according to the present invention includes no authentication step.

The method according to the present invention preferably includes a step of determination of the value of each criterion field for the given resource. This step can be executed by software that interrogates the given resource, which in response transmits the value of each criterion field. Alternatively, the software can have a representation of the resources in the set of resources so that it knows the value of each criterion field for each resource. The invention is not limited by the manner in which this determination is carried out.

Moreover, the method according to the present invention need not include this step of determination of the value of each criterion field for the given resource. For example, the given user may wish to apply the given function to all resources matching at least one given criterion. The user can enter the value of each criterion field directly.

The present invention also consists in an access control module for determining if a given user from a set of users can apply a given function from a set of functions to a given resource from a set of resources, which resources can be classified in accordance with at least one criterion. The access control module of the invention includes:

a user variable,

a list of criterion variables structured as at least one criterion variable, each criterion variable corresponding to a particular criterion, and

authorization determination means using a user group identifier received by the access control module and a list of values received by the access control module including, for at least one criterion variable from the list of criterion variables, a value of the particular criterion for the given resource.

The prior art access control modules include the identifiers of all resources in the set of resources, and where appropriate a list of groups, to enable a two-stage determination process. If a resource identifier is received by the access control module, the access control module determines to which resource group the received identifier belongs, and then determines if authorization should be given or not on the basis of the resource group identified in this way and a received user identifier.

The access control module according to the present invention avoids this first step: together with the received user group identifier, it is the list of values received that determines the authorization, and not a value retrieved using a received identifier. Thus the access control module according to the present invention does not need to store the identifiers of all the resources from the set of resources.

The access control module according to the invention is in fact intended to receive the message of the method according to the present invention and therefore has the same advantages as the method according to the present invention. It can be adapted for the same preferred features, without the latter being limiting on the invention.

For example, the access control module according to the invention can advantageously include a list of criterion variables, each criterion variable corresponding to a particular criterion.

The access control module according to the invention can advantageously include a function variable. The determination means can also take into account a function identifier received by the access control module.

The access control module according to the present invention can operate with a prior art software module, and, reciprocally, the software module according to the present invention can operate with a prior art access control module.

The present invention also consists in an access control device for implementing the method according to the present invention, including an access control module according to the present invention. The access control device determines if a given user from a set of users can apply a given function from a set of functions to a given resource from a set of resources. The set of resources advantageously includes software resources.

The software resources include a software product. Thus the access control device determines if a given user can apply a given function to a software product.

Alternatively, the resources can include hardware resources, such as doors.

The software resources advantageously include network equipments of a computer telecommunication network. The network equipments can include routers, for example. Here the method according to the present invention finds a particularly advantageous application given the large number of routers possible in such a network. This application is not limiting on the invention, of course.

The access control device can include the software module and the access control module, for example. The software module includes software for generating messages including a user field and a list of fields structured as at least one criterion field, each criterion field containing the value of a particular criterion for the given resource. The software module and the access control module can be integrated into the same device, for example a network management tool, or into a plurality of separate devices.

The invention is described in more detail hereinafter with reference to figures representing a preferred embodiment of the invention.

FIG. 1, already commented on, illustrates the operation of one example of a prior art access control device.

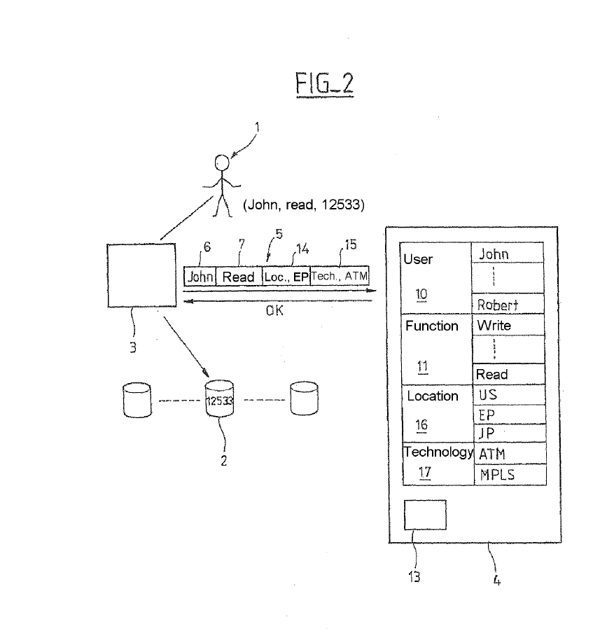

FIG. 2 illustrates one example of the operation of one example of an access control device according to a preferred embodiment of the present invention.

It will be noted that identical or similar elements or parts have been designated by the same reference symbols in the figures.

In the example illustrated by FIG. 2, a given user 1 wishes to apply to a given resource, here a given router 2, a given function, here a function that reads a file or a program of the router 2. The given router 2 is identified by the identifier 12533.

The given user 1 is authenticated by a software module 3 and formulates his enquiry so that the software module 3 receives an identifier of the given resource and an identifier of the given function.

The given resource 3 is part of a set of resources. Routers can be classified according to two criteria: location and technology.

The software module 3 sends a message 5 to an access control module 4 to determine if the given user 1 can access its enquiry. The access control module 4 sends its agreement or its refusal in response to the received message.

The access control module is created with a user variable 10, a function variable 11, and a list of criterion variables. The list of criterion variables includes a location variable 16 and a technology variable 17.

If the access control module 4 is installed in order to manage access to all of the resources concerned, here routers of a particular computer telecommunication network, a person has to configure the access control module. For at least one criterion variable, the person enters a set of potential values of the corresponding particular criterion for the resources in the set of resources concerned. In the example illustrated, the computer network includes routers in Europe, the United States and Japan: there are therefore three potential values of the location criterion at the time of installation. Similarly, the routers of this network can be ATM routers or MPLS routers, so that there are two potential values for the technology criterion for the set of resources concerned. The sets of potential values therefore depend on the set of resources. The access control module can include a criterion variable with no set of associated potential criterion values. The sets of potential values can also evolve.

When the access control module is configured, the person must be up to date on the sets of potential values. These can be printed out on a paper (or electronic) document for this purpose. Unlike the prior art paper document, this paper document does not include any list of the identifiers of all the resources of the set of resources concerned.

These sets of potential values can be modified afterwards, for example by an administrator program.

In the example illustrated by FIG. 2, the software module 3 determines, for the given resource, the value of a location criterion field and the value of a technology criterion field. The software module 3 contains a representation of each resource in the set of resources and can determine the value of the location criterion and the value of the technology criterion for each resource in the set of resources.

The software module 3 therefore generates and transmits the message 5. The message 5 includes:

a user field 6 containing an identifier of the given user,

a function field 7 containing an identifier of the given function, and

a list of fields structured as two criteria fields (14, 15).

Each criterion field (14, 15) contains an identifier of a particular criterion and the value of that particular criterion for the given resource 2. A location field 14 contains an identifier of the location criterion, “loc” in the figure, for example, and the value “Europe” or an identifier of that value, while a technology field 15 contains an identifier of the technical criterion, “tech” in the figure, and the value “ATM” or an identifier of that value.

The message 5 can be transmitted in accordance with a free or fixed protocol. The protocol chosen is in no way limiting on the present invention.

A free protocol makes use more flexible: for example, the given user 1 may wish to apply a given function to all routers of a given technology, for example all ATM routers. The software modules 3 can then generate a message including:

a user field containing an identifier of the given user,

a function field containing an identifier of the given function, and

a list of fields structured as a single criterion field; the criterion field contains an identifier of the technology criterion and the value “ATM” of that criterion.

The message can be generated and transmitted once only: if authorization is obtained, the given user can apply the given function to all ATM routers. The software module can equally, and preferably, transmit this message more than once, for example before each application of the given function to one of the ATM routers.

When the access control module 4 receives the transmitted message 5, authorization determination means 13 determine the authorization on the basis of the received user identifier, the received function identifier, the received location criterion value, and the received technology criterion value.

The access control module then sends the software module a binary response authorizing or not authorizing the given user 1 to apply the given function to the given resource.

The access control module can send a response other than an authorization or a non-authorization: in particular, the access control module can send an error message, for example if the list of fields of the received message includes a criterion field containing an identifier of a criterion not known to the access control module.

1. Access control method for determining if a given user (1) from a set of users can apply a given function from a set of functions to a given resource (2) from a set of resources having identifiers, which resources can be classified in accordance with at least one criterion, the method including a step of transmitting to an access control module (4) that has not stored the identifiers of the resources a message (5) including:
a user field (6) containing a group identifier of the given user, and
a list of fields structured as at least one criterion field (14, 15), each criterion field containing the value of a particular criterion for the given resource.

2. Method according to claim 1, wherein the list of fields is structured as a plurality of criterion fields (14, 15).

3. Method according to claim 1, wherein the transmitted message (5) also includes a function field (7) containing an identifier of the given function.

4. A method according to claim 1, wherein each criterion field also contains an identifier of the particular criterion.

6. Method according to claim 1, including a preliminary step of authentication of the given user (2).

6. Method according to claim 1, including a step of determination of the value of each criterion field (14, 15) for the given resource (2).

7. Access control module (4) for determining if a given user (1) from a set of users can apply a given function from a set of functions to a given resource (2) from a set of resources, which resources have identifiers and can be classified in accordance with at least one criterion, including:
a user variable,
a list of criterion variables structured as at least one criterion variable (16, 17), each criterion variable corresponding to a particular criterion, and
authorization determination means (13) using:
a user group identifier received by the access control module, and
a list of values received by the access control module including, for at least one criterion variable from the list of criterion variables, a value of the particular criterion for the given resource,
the access control module not having stored the identifiers of the resources.

8. Access control device for implementing a method for determining if a given user (1) from a set of users can apply a given function from a set of functions to a given resource (2) from a set of resources having identifiers, which resources can be classified in accordance with at least one criterion, the method including a step of transmitting to an access control module (4) that has not stored the identifiers of the resources a message (5), said message including a user field (6) containing a group identifier of the given user, and a list of fields structured as at least one criterion field (14, 15), each criterion field containing the value of a particular criterion for the given resource, said control device including the access control module (4) according to claim 7, the access control device determining if a given user (1) from a set of users can apply a given function from a set of functions to a given resource (2) from a set of resources, the set of resources including software resources.

9. Control device according to claim 8, the software resources including network equipments of a computer telecommunication network.
